(19) United States
(12) Patent Application Publication
(10) Pub. No.: US 2014/0357332 A1
(43) Pub. Date: Dec. 4, 2014

(54) GEOMETRY FOR CONTROLLING AIR VELOCITY IN A COMBINE HARVESTER

(71) Applicants: Joseph Biggerstaff, Wichita, KS (US); Anthony Ward, Hesston, KS (US); John Medbery, Buhler, KS (US)

(72) Inventors: Joseph Biggerstaff, Wichita, KS (US); Anthony Ward, Hesston, KS (US); John Medbery, Buhler, KS (US)

(73) Assignee: AGCO Corporation, Duluth, GA (US)

(21) Appl. No.: 14/234,203

(22) PCT Filed: Jul. 26, 2012
(86) PCT No.: PCT/US12/48222

§ 371 Date: Apr. 7, 2014

Related U.S. Application Data
(60) Provisional application No. 61/512,041, filed on Jul. 27, 2011.

(51) Int. Cl. A01F 12/44

(52) U.S. Cl. CPC A01F 12/44
USPC 460/99

(57) ABSTRACT

A combine harvester has a threshing mechanism for threshing grain and cleaning apparatus for removing chaff from the threshed grain. The threshing mechanism includes a plurality of concaves and the cleaning apparatus includes and upper chaffer and a lower sieve. The combine harvester also has a blower having a rotating impeller and a blower housing. The blower housing has a first duct that directs a first airstream onto the upper chaffer and lower sieve, and a second duct that directs a second airstream along the underside of the concaves. An inlet to the second duct has a cross-sectional area that is larger than the cross-sectional area of an outlet of the second duct. The blower has a divider plate that separates high-velocity air from the impeller and directs the high-velocity air to either the first duct or the second duct.

### BACKGROUND OF THE INVENTION

1. Field of Invention

This invention relates to threshing and cleaning systems for combine harvesters, and more particularly, to a blower mechanism for managing the airflow through the threshing and cleaning systems of the combine harvester.

2. Description of Related Art

Combine harvesters have a threshing mechanism for threshing the harvested crop and a cleaning system used to remove chaff and other residue from the threshed crop. In one example, a rotor cooperates with concaves to thresh the harvested material, and initial separation occurs as grain and smaller residue are pushed through the grated concaves by centrifugal force to the cleaning system. Large residue pieces such as stalks and stems continue to move rearwardly and are eventually discharged out the rear end of the rotor assembly where it is acted upon by a chopper or spreader and deposited on the ground.

Within the cleaning system, oscillating sieve assemblies in conjunction with air flow remove the chaff from the threshed grain, which gravitates through the chaffer and sieve assembly to an oscillating clean grain pan. The clean grain pan, in turn, directs the clean grain to a discharge auger that elevates the grain to an onboard storage bin. A second oscillating pan directs materials other than grain over the edge of the bottom sieve assembly to a different discharge outlet for recirculation back through the threshing, separating and cleaning apparatus to extract the previously unthreshed grain.

A blower may be used to produce an airstream that entrains the lighter non-grain particles and carries them out the rear of the harvester. However, it can be challenging to control the airflow from the blower to get an even distribution of air across both the threshing mechanism and the cleaning system.

### OVERVIEW OF THE INVENTION

In one embodiment, the invention is directed a combine harvester having a threshing mechanism for threshing grain and cleaning apparatus for removing chaff from the threshed grain. The threshing mechanism includes a plurality of concaves and the cleaning apparatus includes and upper chaffer and a lower sieve. The combine harvester also has a blower having a rotating impeller and a blower housing. The blower housing has a first duct that directs a first airstream onto the upper chaffer and lower sieve, and a second duct that directs a second airstream along the underside of the concaves. An inlet to the second duct has a cross-sectional area that is larger than the cross-sectional area of an outlet of the second duct. The blower has a divider plate that separates high-velocity air from the impeller and directs the high-velocity air to either the first duct or the second duct.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic side elevational view of a combine harvester with parts broken away to reveal internal details of the feeding, threshing, separating and cleaning portions of the machine;

FIG. 2 is a side view of a portion of the combine harvester off FIG. 1 showing a blower according to an embodiment of the invention;

FIG. 3 is a perspective view of the blower of the combine harvester of FIG. 2;

FIG. 4 is a side elevational view of the impeller and the upper duct of the blower of FIG. 2;

FIG. 5 is a perspective view of the upper duct of the blower of FIG. 2; and

FIG. 6 is another perspective view of the upper duct of the blower of FIG. 2.

Corresponding reference characters indicate corresponding parts throughout the views of the drawings.

### DESCRIPTION OF EXAMPLE EMBODIMENTS

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments. References hereinafter made to certain directions, such as, for example, “front”, “rear”, “left” and “right”, are made as viewed from the side of the combine.

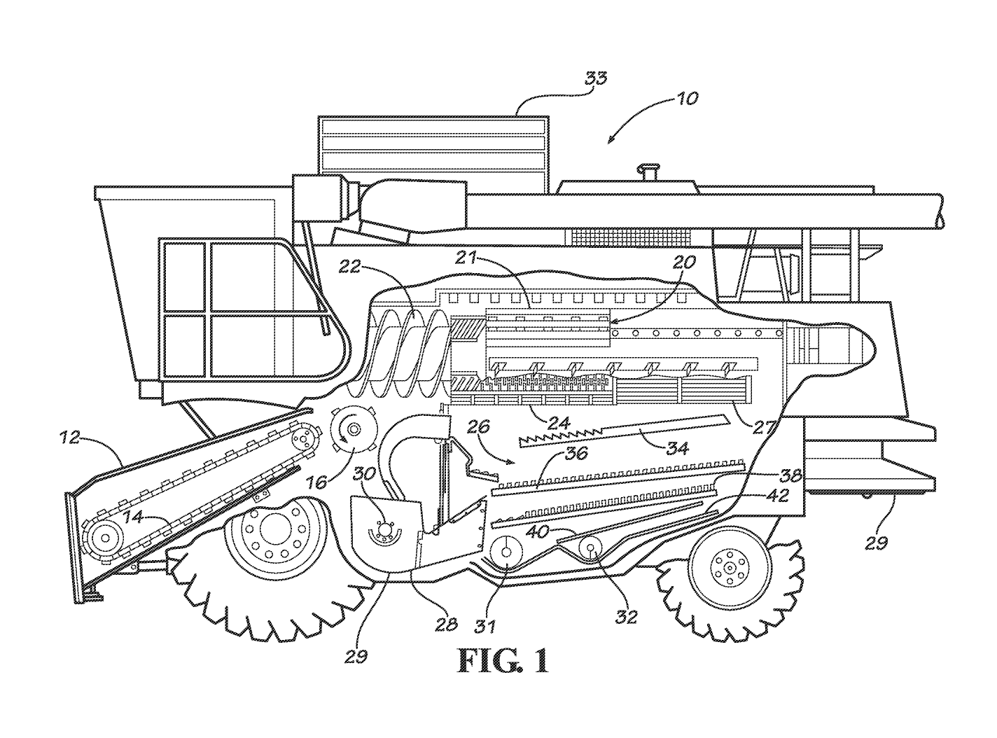

FIG. 1 schematically illustrates one type of combine harvester 10 to which the present invention relates. Although the harvester 10 chosen for purposes of illustration is a so-called axial rotary combine in which the threshing mechanism comprises a rotor disposed axially of the machine with respect to its fore-and-aft axis, many other types of threshing and separating mechanisms are currently in commercial use and it is not intended that the principles of the present invention be limited to any one particular type of threshing and separating mechanism.

In relevant part, harvester 10 has a feed housing 12 that receives harvested materials from a suitable header (not shown) and advances such materials upwardly and rearwardly via a conveyor 14 toward a beater 16 rotating in a counterclockwise direction viewing FIG. 1. Beater 16 impels the harvested materials upwardly and rearwardly into a receiving housing 18. Housing 18 contains the front end of a threshing mechanism, broadly denoted by the numeral 20. In the illustrated embodiment, the threshing mechanism 20 comprises a rotor 21 with a front end having a series of helical vanes 22 that start the materials moving rearwardly in a spiral path of travel along the outside of the rotor 21. As the materials move rearwardly, concaves 24 cooperate with rotor 21 to thresh the materials, and initial separation occurs as grain and smaller residue are pushed through the grated concaves region by centrifugal force to the cleaning apparatus 26. Large residue pieces such as stalks and stems continue to move rearwardly past a separating grate 27 which allows grain to pass radially out of the rotor area to cleaning apparatus 26, but not the larger residue. Such residue eventually discharges out the rear end of the rotor assembly where it is acted upon by a chopper or spreader (now shown) and deposited on the ground. One skilled in the art will understand that other threshing and separating mechanisms 20, such as a cylinder and concaves, may be used without departing from the scope of the invention.

Generally speaking, the threshed grain works its way downwardly through the machine as it is acted upon by the cleaning apparatus 26 and a blower 28. The blower 28 has a blower housing 29 which contains a rotatable impeller 30 configured to generate a high-velocity stream of air. The light chaff particles become airborne by the rearwardly directed airstream generated by the blower 28 and are discharged out the rear of the machine. Clean grain ultimately finds its way to a discharge auger 31 leading to an elevator that conveys the clean grain up to a storage tank 33 at the top of the machine. Tailings, consisting of some grain along with other particles of residue, find their way to a tailings return auger 32 which then elevates the tailings via means not illustrated for recirculation back through the threshing, separating and cleaning areas to further separate grain from such residue.

The combine harvester 10 includes as part of its cleaning apparatus 26 an upper oscillating pan 34 that delivers materials received from concaves 24 and grate 27 generally downwardly and forwardly. Those materials from pan 34 land on an upper oscillating upper chaffer 36. The upper chaffer 36 allows grain to pass downwardly through openings in the upper chaffer 36 while larger particles are impelled generally upwardly and rearwardly until being discharged off the rear end of the upper chaffer 36 and out the back of the combine harvester 10 to the ground. A finer oscillating lower sieve 38 receives the grain and residue that has passed through the upper chaffer 36 and performs essentially the same type of classifying function as upper chaffer 36. The smaller kernels of grain fall through the lower sieve 38 and onto an oscillating grain pan 40, which delivers the grain into the clean grain auger 30. The larger tailings particles unable to penetrate lower sieve 38 travel off the rear discharge end of lower sieve 38 and drop to a tailings return pan 42 that feeds such materials to the tailings return auger 32. As the kernels of grain gravitate through upper and lower sieves 36 and 38, the airstream from fan 28 entrains the light non-grain particles and carries them out the rear of the machine.

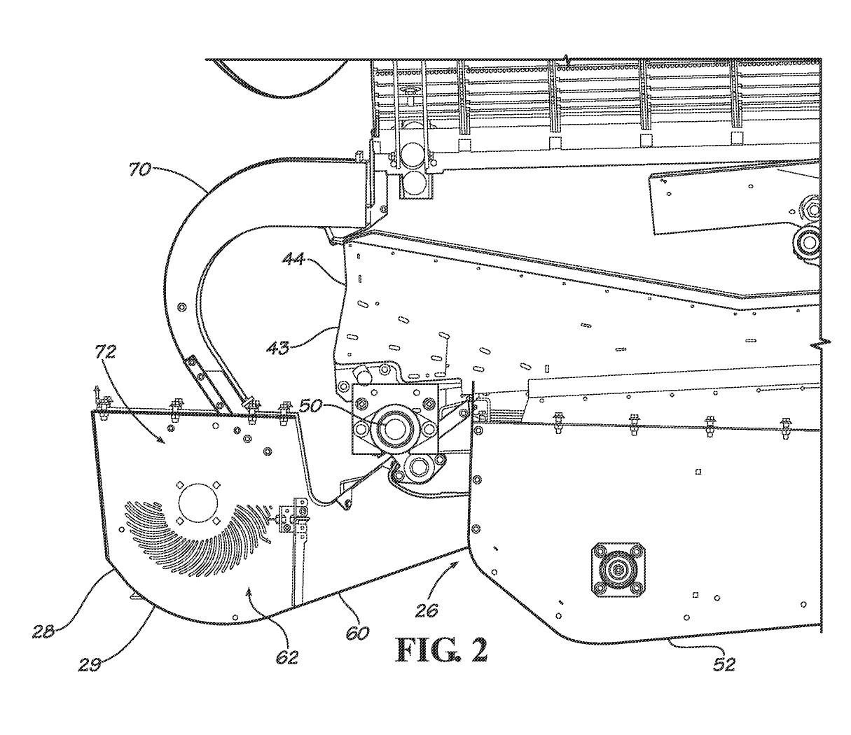

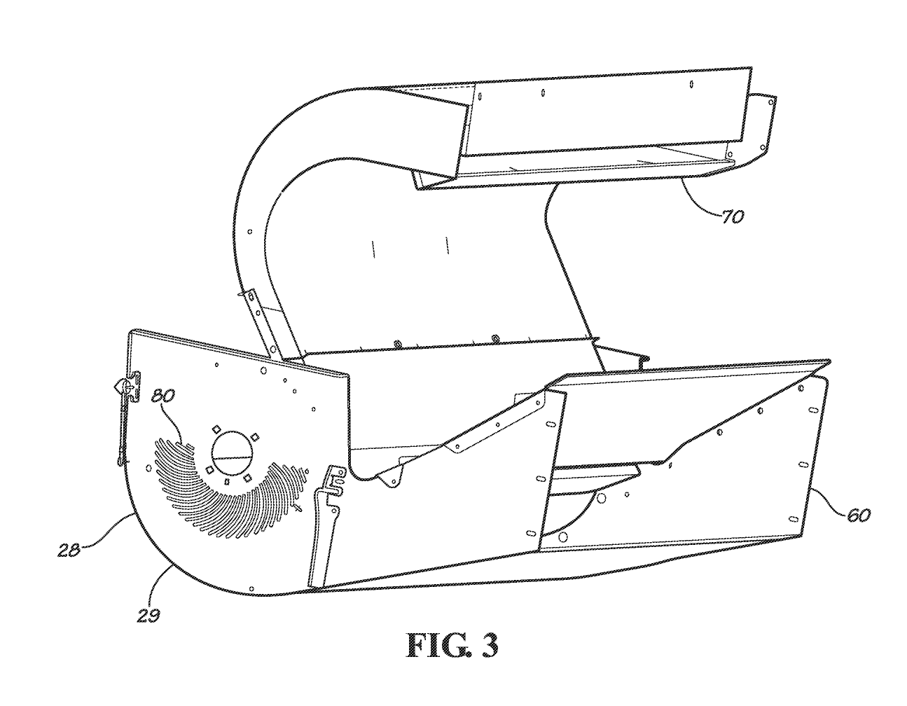

Turning now to FIGS. 2 and 3, somewhat enlarged and partially broke away views of one embodiment of the cleaning apparatus 26 and blower 28 are illustrated. The upper chaffer 36 and lower sieve 38 (FIG. 1) of the cleaning apparatus 26 are supported by a frame 43. In the illustrated embodiment, upper chaffer 36 is supported on an upper portion 44 of frame 43. The upper portion 44 is connected to a transverse, oscillating jackshaft 50 using any suitable means as is known in the art. In one embodiment, the lower sieve 38 is desirably mounted on a common lower portion 52 of frame 43 it shares with the clean grain pan 40 and tailings return pan 42 (FIG. 1). At its front end, the lower portion 52 is suspended from the oscillating shaft 50 via a suitable pivot connection as is known in the art. Driving power for oscillating the upper and lower portions 44, 52 of the frame 43 is provided by a suitable eccentric input drive unit connected to the jackshaft 50 so as to cause oscillating rotation of the shaft 50.

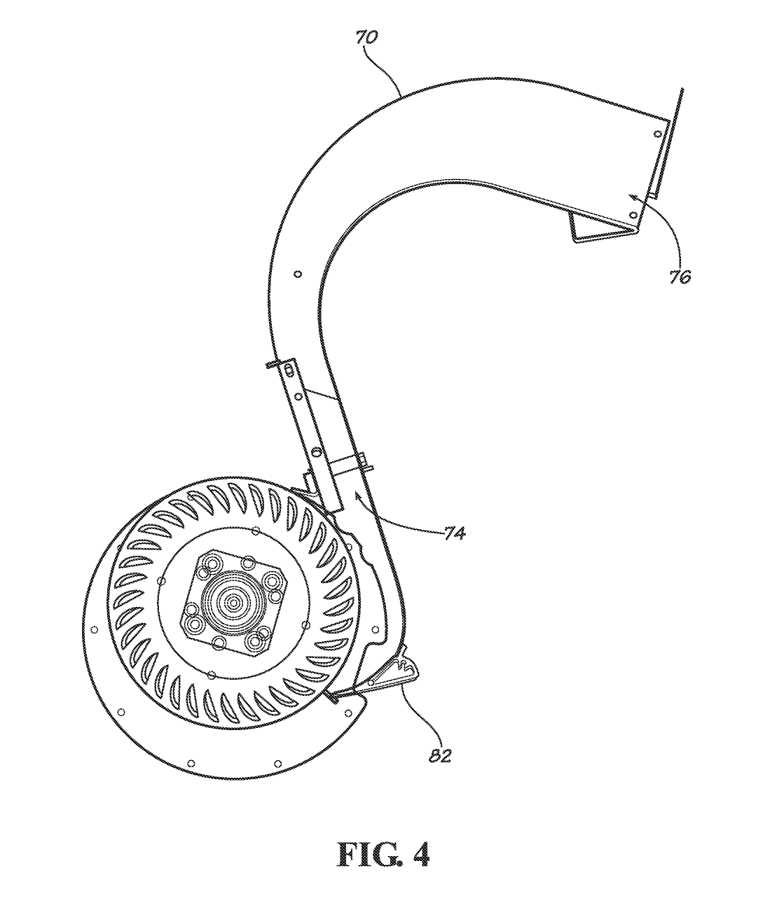

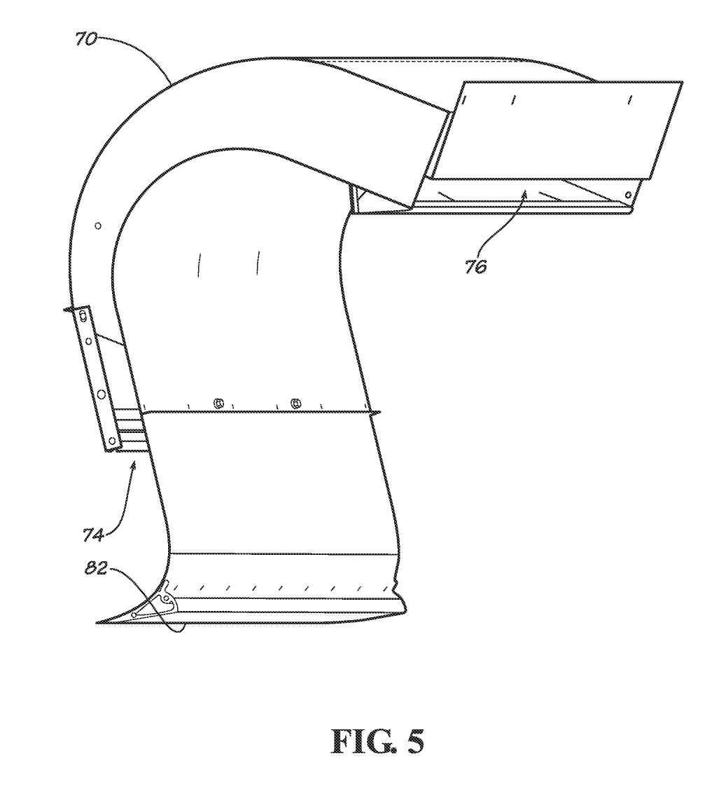

The blower housing 29 has a first duct 60 that directs a first airstream from the blower 28 out of a lower portion 62 of the blower housing 29. The first duct 60 connects with the frame 43 and directs its airstream toward the upper chaffer 36 and lower sieve 38. The blower housing 29 has a second duct 70 that directs a second airstream from the blower 28 out of an upper portion 72 of the blower housing 29. The second duct 70 directs an airstream immediately under the rotor 20 and concaves 24. Desirably, the blower housing 29 and first and second ducts 60, 70 are configured with an elongated width such that the ducts 60, 70 direct the airstreams along substantially the entire width of the concaves 24 and upper chaffer 36 and lower sieve 38. The blower housing 29 contains a plurality of vents 80 designed to permit air to enter the housing and reach the impeller 30. As best seen in FIGS. 4 and 5, the blower 28 has a divider plate 82 that separates the high-velocity air from the impeller 30 and directs the high-velocity air to either the first duct 60 or the second duct 70.

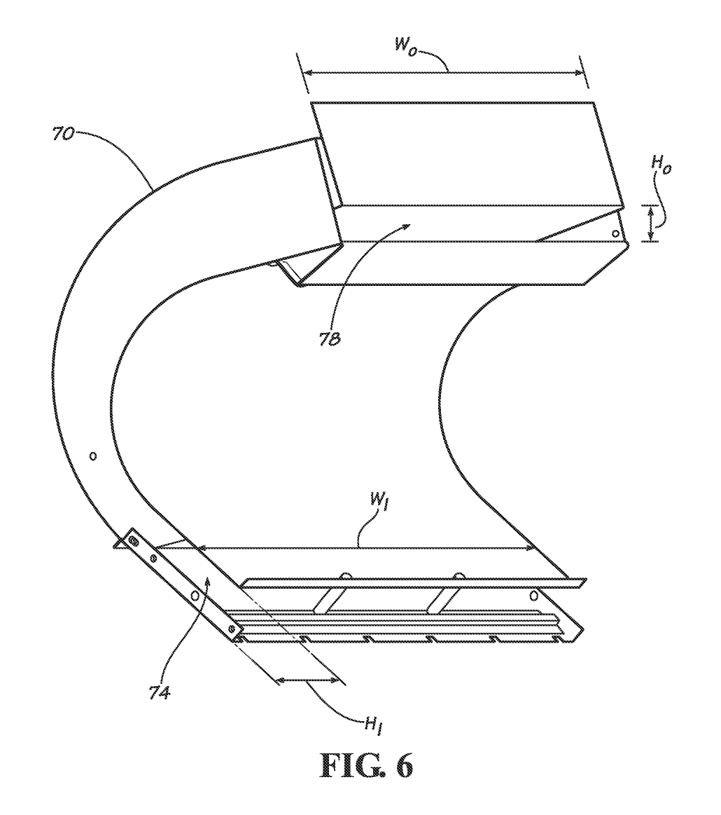

Turning now to FIG. 6, an inlet 74 to the second duct 70 has a shape such that its cross-sectional area is larger than the cross-sectional area of an outlet 76 of the second duct 70. In the illustrated embodiment, the second duct 70 has substantially identical inlet and outlet widths W_{I} and W_{O}, but the inlet 74 to the second duct 70 has a height H_{I} that is larger than the height H_{O} of its outlet 76. However, one skilled in the art will understand that the inlet 74 could have differences in the width dimension W_{I}, or in both the width W_{I} and height dimensions H_{I}, with respect to the width and height dimensions W_{O} and H_{O} of the outlet 76 to provide the larger cross-sectional area. In one embodiment, the inlet has a height H_{I} of 60 mm and the outlet has a height H_{O} of 50 mm. Desirably, the cross-sectional area of the inlet 74 is between about 100% and 140% the cross-sectional area of the outlet 76, and more preferably between about 110% and 130% of the cross sectional area of the outlet 76.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A combine harvester having a threshing mechanism for threshing grain and cleaning apparatus for removing chaff from the threshed grain, wherein the threshing mechanism comprises a plurality of concaves and the cleaning apparatus comprises and upper chaffer and a lower sieve, wherein the improvement comprises:
a blower comprising a rotating impeller and a blower housing, wherein the blower housing has a first duct that directs a first airstream onto the upper chaffer and lower sieve, and a second duct that directs a second airstream along the underside of the concaves, wherein an inlet to the second duct has a cross-sectional area that is larger than the cross-sectional area of an outlet of the second duct.

2. The combine harvester of claim 1 wherein the first and second ducts have elongated widths such that said ducts direct the airstreams along substantially the entire width of the concaves, upper chaffer and lower sieve.

3. The combine harvester of claim 1 wherein the blower has a divider plate that separates high-velocity air from the impeller and directs the high-velocity air to either the first duct or the second duct.

4. The combine harvester of claim 1 wherein the second duct has substantially identical inlet and outlet widths and but an inlet height that is larger than an outlet height.

5. The combine harvester of claim 1 wherein the cross-sectional area of the inlet is between about 110% and 130% of the cross sectional area of the outlet.
